(19) United States
(12) Patent Application Publication
(10) Pub. No.: US 2011/0084176 A1
(43) Pub. Date: Apr. 14, 2011

(54) RAILROAD CROSSING

(76) Inventors: Kevin Allan Reichelt, North Perth (AU); Donald Stephen Searle, Bindoon (AU)

(21) Appl. No.: 12/734,956

(22) PCT Filed: Dec. 4, 2008
(86) PCT No.: PCT/AU2008/001791

§ 371 Date: Dec. 13, 2010

(30) Foreign Application Priority Data
Dec. 4, 2007 (AU) 2007906616

(51) Int. Cl. B61L 29/30; G01B 11/14; G01P 15/00

(52) U.S. Cl. 246/473.1; 356/621; 73/490

(57) ABSTRACT

A method of operating a railway crossing including the steps of receiving a signal from a locomotive; and activating crossing warning devices and/or downroad warning and in-vehicle alert devices.

### FIELD OF THE INVENTION

The invention relates generally to railroad crossing systems. In particular, the invention relates to the indication and capture of crossing conditions.

### BACKGROUND TO THE INVENTION

The movement of passengers and freight is vital and in most industrialised economies it is one of the safest growing modes of transport. But around the world, railroad crossings stilt represent a potential high risk for rail operators, pedestrians and road users. Railroad crossings, intersections where a railroad track crosses a roadway, have long presented a significant danger for vehicular traffic. Each year many car/train accidents occur at these locations.

Extensive measures have been adopted at railroad crossings to provide a safer environment for all users. This has included flashing lights, vehicle and pedestrian boom gates and other warnings systems to notify motorists and pedestrians of the presence of trains near or approaching the railroad crossing. The presence of an approaching train activates these safety mechanisms prior to the train entering the railroad crossing. The warning signal usually continues to operate for a short period of time after the train has passed through the railroad crossing.

A major drawback of conventional railroad crossing systems is the expense associated with installing and maintaining these systems. Further, these arrangements provide only limited information to vehicle operators concerning the approaching train. Specifically, only the fact that a train is approaching the crossing is indicated.

With the abovementioned safety measures in place, as well as the implementation of driver education programs, there are still too many accidents occurring at railroad crossings. These accidents extract a high toll in injury and death, and impose a large economic cost on the community.

The cause of railroad crossing accidents can be categorised into a couple of key areas:

i) When a road vehicle driver is unaware of the crossing, this may be because the driver is unfamiliar with the area and didn't know there is a railroad crossing on the road;

ii) When a road vehicle driver sees the crossing, and fragrantly breaks the law. The driver assess the situation and decides to ‘beat the train’ whether or not there are flashing lights installed warning of an approaching train. Or they are impatient, and attempt to drive through the crossing or around the boom gates. Not only are they breaking the law—these actions often end in tragedy.

The applicant's international application number PCT/AU2005/000624, the contents of which are herein incorporated by reference, proposes a train integrity network system comprising bogie units which monitor critical parameters relating to the condition of bogie components and the rail track they are travelling on The system includes an onboard server which controls the bogie units and a wireless network which enables communication between the server and the bogie units.

There is a need for an improved railroad crossing system and method that provides for an accurate detection of trains approaching, traversing, resting within and exiting the detection area associated with a railroad crossing which adequately covers the detection area.

It is therefore desirable to provide an improved railroad crossing system that overcomes or alleviates one or more of the above described disadvantages.

Any discussion of documents, acts or knowledge in this specification is included to explain the context of the invention. It should not be taken as an admission that any of the material forms part of the prior art base or the common general knowledge in the relevant art.

### SUMMARY OF THE INVENTION

In one aspect the present invention provides a method of operating a railway crossing including the steps of:

receiving a signal from a locomotive;

determining whether said crossing is obstructed; and

communicating whether said crossing is obstructed to said locomotive.

In another aspect the present invention provides a method of managing the approach of a locomotive to a crossing including the steps of:

sending a signal from said locomotive to said crossing; and

if unable to initiate communications between said locomotive and said crossing taking predetermined steps to control the approach of said locomotive to said crossing.

In a further aspect the present invention provides a rail crossing safety system including

a communications means adapted to send and receive signals to a locomotive;

a video capture means to capture images of said crossing; and

a processor to determine if said crossing is obstructed;

and wherein said system communicates to said locomotive whether said crossing is obstructed.

In still another aspect the present invention provides a system for detecting the approach of vehicles on a road including:
a first pair of posts located on opposite sides of said road; and a second pair of posts located on opposite sides of said road; said first pair of posts and said second pair of posts forming the corners of a quadrilateral; wherein a first beam is transmitted between said first pair of posts, and a second beam is transmitted between said second pair of posts; and

a processor for detecting if said first beam is broken, and whether said second beam is broken indicating the passing of a vehicle between said first and second pair of posts.

In yet another aspect the present invention provides a method for detecting the approach of vehicles on a road including the steps of:

transmitting a first beam between a first pair of posts located on opposite sides of a road, and transmitting a second beam between a second pair of posts located on opposite sides of a road, wherein said first pair of posts and said second pair of posts form the corners of a quadrilateral; and

detecting if said first beam is broken, and whether said second beam is broken thereby indicating the passing of a vehicle between said first and second pair of posts.

In a further aspect the present invention provides a rail crossing safety system including

a first module located on a locomotive, said first module including a first communication means; and

a second module located at a crossing, said second module including

a second communications means adapted to send and receive signals from said first communication means;

a video capture means to capture images of said crossing; and

a processor to determine if said crossing is obstructed;

and wherein said second module communicates to said first module whether said crossing is obstructed.

In another aspect the present invention provides a method of operating a railway crossing including the steps of:

receiving a signal from a locomotive; and

activating crossing warning devices and/or downroad warning devices.

In a further aspect the present invention provides a method of managing the approach of a locomotive to a crossing including the steps of:

sending a signal from said locomotive to said crossing; and

if unable to initiate communications between said locomotive and said crossing alerting a driver of said locomotive.

In still another aspect the present invention provides a rail crossing safety system including

a communications means adapted to send and receive signals to a locomotive; and

at least one safety device;

wherein said system activates said at least one safety device following receipt of a signal from said locomotive.

According to one aspect the present invention provides a rail crossing protection system and method for a railroad crossing, said rail crossing protection system and method including:

at least one train on at least one train line, wherein said at least one train approaching a railroad crossing activates said rail crossing protection system;

said at least one train including:
i) a data server for storing train information and generating periodic messages;
ii) a communication means for transmitting said train information and periodic messages to said rail crossing protection system;
iii) a receiving means for receiving railroad crossing information from said rail crossing protection system; and
iv) a location determining means which recognises the location of the train with respect to a railroad crossing; said rail crossing protection system including:
i) a power source;
ii) a controller for receiving said periodic messages from said train to activate said rail crossing protection system; and
iii) a means for providing an indication of crossing condition to paid train approaching the railroad crossing.

The communication means could be wireless, satellite or GPS communications link.

In a preferred arrangement the at least one train includes a train integrity network system comprising bogie units which monitor critical parameters relating to the condition of bogie components and the rail track they are travelling on. The system includes an onboard server which controls the bogie units and a wireless network which enables communication between the server and the bogie units.

The train integrity network system preferably enables the train when it enters into radio range of a railroad crossing to poll the crossing using the wireless network.

The at least one train preferably includes a GPS system for satellite communication with the rail crossing protection system.

Inclusion of a GPS system also enables the position of the train to be known. Accordingly the train will know when it is in proximity of a crossing and will then be able to poll the crossing. In the alternative the crossing may be configured to poll for trains at predetermined intervals.

In a preferred arrangement the railroad crossing protection system includes crossing lights and warning signals which are activated by an approaching train at the railroad crossing and also at a pre-determined distance from the crossing the distance determined by the terrain and visibility around the railroad crossing.

The rail crossing protection system preferably includes image processing to provide an indication of railroad crossing condition to reliably recognise and provide output data in accordance with predetermined size and shapes day or night.

The image processing preferably includes real time image capture of the railroad crossing condition.

The real time image captured being preferably transmitted to said at least one train approaching the railroad crossing to provide an alarm and indication should the railroad crossing be in an unsafe condition.

The image processing preferably includes an infra-red camera.

In a preferred arrangement the railroad crossing protection system includes a zero visibility approach network. Zero or very poor visibility to IR or visible spectrum such as heavy fog, rain, snow and mist, may render the crossing video detection system unreliable or useless.

In a further preferred arrangement the railroad crossing protection system further includes an in-vehicle system to further aid the decision process at the railroad crossing.

In a further preferred arrangement the rail crossing protection system includes is the ability to switch on ‘down-the-road’ warning lights as a train polls the crossing and activates the crossing and the ability to activate an ‘in-cabin’ alert in a vehicle approaching the crossing. The system further includes the ability to extend this in-cabin system into an interactive, ‘black-box’ system to monitor driver behaviour as they approach the crossing. This recording of a driver's behaviour through an entire journey could be downloaded at the depot and reviewed by management for transgressions and action or remediation.

The present invention provides a low-cost, effective railroad crossing solution by providing an identification and warning to drivers approaching any passive railroad crossing in a network, and secondly, the ability to monitor all road traffic behaviour at a crossing. The system offers an integrated solution for, or substitution of, existing signalling methods for risk minimisation, train tracking and track performance, and accident prevention at both passive and active road and railroad crossings. The present invention also provides for video capture of every ‘incident’ and web-based flexibility which includes up-to-date reporting. The video capture of any incident that occurs can be deployed alongside conventional crossing protection systems to improve safety, be used as an educational and law enforcement tool.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

FIG. 1 shows a block diagram overview of the system in accordance with an embodiment of the present invention;

FIG. 2 shows a block diagram of the apparatus located at a railroad crossing in accordance with an embodiment of the present invention;

FIG. 3 shows a block diagram of the zero visibility approach network in accordance with an embodiment of the present invention;

FIG. 4 shows an example of the output from the zero visibility approach network of FIG. 3;

FIG. 5 shows a timing diagram for train initiation of the railroad crossing system and the zero visibility approach network in accordance with an embodiment of the present invention;

FIG. 6 shows a block diagram of the apparatus located on board a train in accordance with an embodiment of the present invention;

FIG. 7 shows a diagrammatical representation of stopping distances for trains and motor vehicles;

FIG. 8 shows a table and graph of the estimated stopping time for a heavy motor vehicle; and

FIG. 9 shows a table and graph of the estimated stopping distance for a loaded train.

### DESCRIPTION OF PREFERRED EMBODIMENT

The present invention will be discussed hereinafter in detail in terms of the preferred embodiment of a system and method of an improved railroad crossing according to the present invention with reference to the accompanying drawings. In the following description, numerous specific details are set forth in order to provide a thorough understanding of the present invention. It will be obvious, however, to those skilled in the art that the present invention may be practiced without these specific details.

The improved railroad crossing ideally involves two elements: a train integrity network system (TINS), located in the locomotive and as incorporated by reference from the applicant's international application number PCT/AU2005/000624 and a trackside crossing protection technology (XPT) transponder which is located at each grade crossing.

The TINS server is installed in the locomotive and incorporates the XPT software suite, a GPS module, an RF modem, and a database of gee-referenced road and railroad crossings positions for each rail line segment. The XPT transponders are positioned on an observation pole which allows the system to continuously monitor the crossing and include infra-red software and a self contained power source. The XPT video imaging system can determine if the crossing is obstructed, and transmit a warning to the locomotive engineer.

The XPT transponders can be installed at both passive and active railroad crossings, and powered by either solar energy, wind generators, mains power or by battery. The cost, depending on location, can be less than one third of conventional signalling infrastructure. The XPT system has a range of kilometres, depending on terrain, and repeaters can be installed to extend the range in the case of difficult terrain. Repeaters may also be installed when traffic consists of heavily laden freight or high speed trains where increased distance or advanced notification is required to initiate an emergency response.

When an XPT enabled locomotive enters into radio range of a railroad crossing footprint, the system on the locomotive polls the railroad crossing using the wireless network and once polled the XPT transponder and the XPT server system begin to communicate. The railroad crossing ID is confirmed and the XPT server identifies the crossing. In the instance where the radio network is off-line the system will default to standard operational procedure.

In a further arrangement if a GPS system is installed in the locomotive the system can firstly default to the satellite communications system to hand-shake with the XPT system at a railroad crossing.

Under typical operation when an XPT enabled locomotive enters into radio range of a railroad crossing the crossing lights are then activated both at the intersections and if installed, at the crossing approach warning lights located a distance along the road from the railroad crossing or at a distance dependant on the visibility situation at each crossing, typically 300 metres from the railroad crossing.

The XPT system located at the railroad crossing can continually evaluate the crossing foot-print by continuous image processing, and if the crossing is not obstructed, no alert is broadcast to the locomotive. In this instance, the engineer receives only an acknowledgement from the crossing that the XPT system is working. In the alternative an XPT system located at the railroad crossing may be configured to evaluate the crossing foot print once polled by a system on board a locomotive.

The XPT system could also be used as an operational status alert system, to advise locomotive drivers whether safety measures at a crossing are operational. Thus if a locomotive driver does not receive an indication that the crossing system is working then the driver can undertake a predetermined course of action, such as slowing down to a lesser speed as the crossing is approached.

Should the XPT system sense that the upcoming crossing is obstructed, the on- ground video capture system (if installed) is activated. A real time video capture of the crossing condition is broadcast to the engineer in the approaching locomotive but ideally only if the crossing is obstructed. The real-time video stream may also be recorded until either the obstruction clears, or the train passes through the crossing. By viewing the video or still video capture the locomotive driver is able to ascertain any risk well in advance of reaching the crossing, and to take appropriate action. With the XPT system, the locomotive engineer is able to ascertain the risk level well in advance of reaching the crossing, and depending on operational orders, is in a position to take the appropriate action.

An obstruction can be any item which is obstructing the railroad crossing. In the case of a pedestrian or a small motorised vehicle such as a golf cart or wheel chair obstructing the track and is within the loading gauge for a defined period, the XPT camera can detect the object and provide a warning alert to the driver. A person can also be detected whether they are moving or not.

In the event of an accident, for example, where a motor vehicle drives into the side of a train, or a person leaps in front of the train, the XPT system provides the train operator, police, the insurer and the coroner, with a black box and risk indemnification record of the accident. This record can also be used for education purposes for educating train drivers and the like. The record can also be used for the prosecution of people who fragrantly break the law (repeat offenders) by entering a railroad crossing when flashing lights indicate an approaching train.

It also the case that often near misses can relate to the incompatibility of the timetable of trains to that of road users and repeat offenders often have near misses. Such offenders can be detected by license plate recognition technology which may be optionally installed in the XPT crossing system.

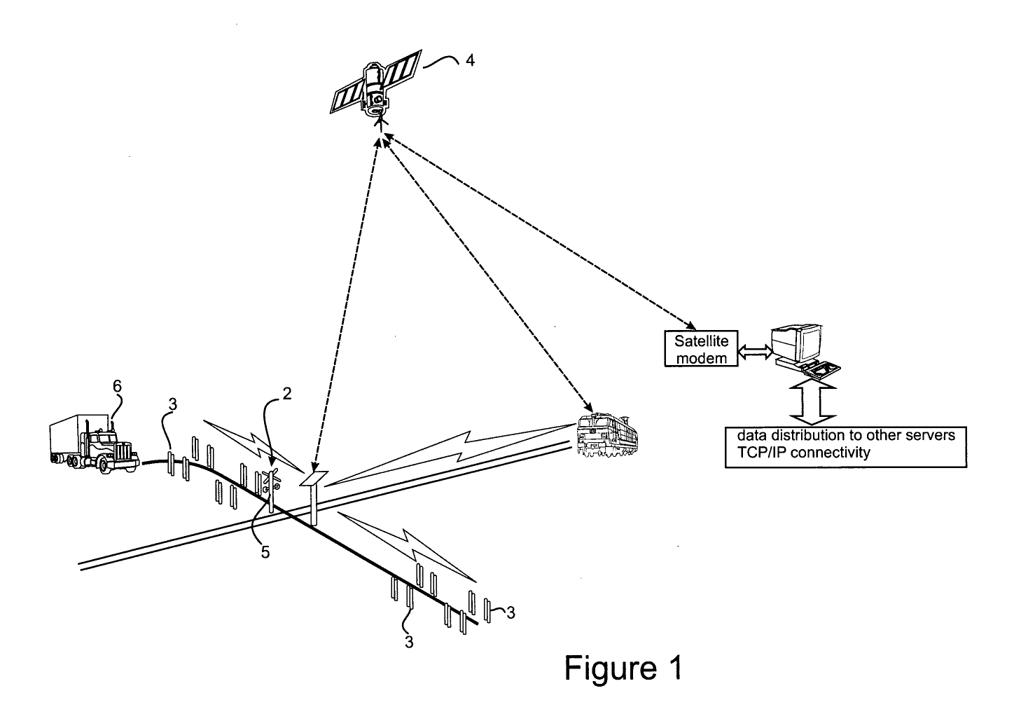

FIG. 1 shows a block diagram overview of the XPT system. It is preferable for most implementations that no equipment is required to be fitted to motor vehicles and other persons/objects capable of causing an incident at rail crossings. It follows, therefore that an efficient level crossing system must be reasonably complex to provide automatic protection and fail safe mechanisms to provide a high level of confidence that it will fulfil its application. Most of the intelligence/decision making of the XPT system will be located at the railroad level crossing. Ideally a split tower of around 4 to 6 meters height is provided at the crossing to support antennas, camera and electronic equipment.

Electronic equipment should preferably be enclosed in an enlarged diameter base section of the tower, with access to the equipment, at ground level, via flush fitting door and lock. The cabinet housing should be strong, waterproof, vermin proof and ventilated. Material should preferably be mild steel with a galvanised finish, as mild steel has better resistance to bullets than aluminium.

The tower, which is around 4 to 6 meters high depending on the terrain and functionality, is envisaged as having a large diameter base section say 250 mm in diameter and around 1.5 meters high reducing to approximately 80 mm for the remaining portion of the tower to bring it to a total height of around 10 meters. The base section of the tower is accessible for installation and maintenance of the equipment which can be sled mounted within the base section.

On the top of the tower a fibreglass dome may be located within which the high power data radio and low power data radio omnidirectional antennas reside. The satellite modem antenna can be attached to the side of the tower just underneath the radome. The camera should be mounted on the tower in a position to ensure coverage of the railway crossing.

Initialisation of the XPT crossing system is instigated by a train (1), whose TINS server has determined that it is near a level crossing (2). Basically the Train system initiates a wake up call to the XPT system by virtue of a long preamble similar to paging systems. The XPT system then initiates a self test routine and transmits back to the train a confirmation of its status. The zero visibility approach network (ZVAN) system (3) (and hence an approaching vehicle) is capable of initialising a crossing but it would appear that such a step is basically unnecessary if no train is present in the immediate vicinity.

Failure of the train to receive confirmation of the crossing status activates the satellite (4) data modem to confirm via the server that the crossing system is functional and that there is only a failure of the data radio system. If not a warning is displayed to the train driver. Assuming that the XPT system is fully operational, the normal warning lights (5) at the crossing (2) flash and approaching vehicles (6) would respond to these in the normal way. We will assume no potential collision scenario exists at this time.

As not all motor vehicle drivers are conscientious, nor are all pedestrians necessarily instilled with common sense, the XPT system must be able to anticipate situations where potentially dangerous situations will occur. If the XPT system logic determines that a status condition changes from normal to potential incident, the train driver is alerted with audible and/or visual warnings that he/she must now slow down to a predetermined speed and observe the screen display. Should the status change to imminent collision, then the train emergency braking system may be applied either manually or automatically as determined by policy makers.

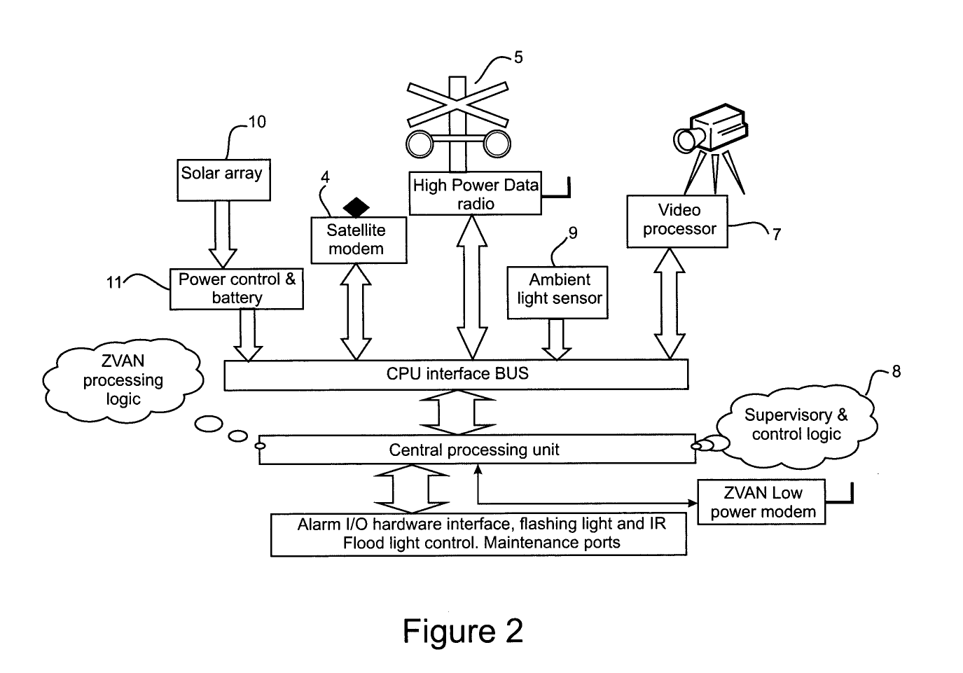

FIG. 2 shows a block diagram of the XPT system and the components of the system located at a railroad crossing. These include the video system (9), satellite modem (4), control and supervisory module (4), and wireless system. Each will be described in more detail below.

The video system includes software to reliably recognise and provide output data in accordance with predetermined size and shapes day or night. The video system should recognise and provide output data for the following:

1. Motor vehicles at a significant distance from the crossing;

2. Persons and objects such as prams in close proximity to the railway tracks;

3. Calculate motor vehicle velocities at a significant distance from the crossing;

4. Compress video suitable for transmission over low speed data links;

5. Store frames in accordance with predetermined conditions;

6. Dump frames in accordance with predetermined conditions;

7. Self calibrate and test using markers; (This is important since heavy fog may obscure video images of the crossing. If a ground fixed marker is not visible then the crossing system recognises that it is blind and this status can be used to inform the locomotive driver.) and

8. Ability to be remotely programmed for number plate recognition for future use. This feature requires approximately sixteen times greater resolution than the standard 1 common intermediate format (CIF) image. Downloading an image of the required resolution will also require considerable satellite time.

The satellite modem (4) will provide uplink for supervisory and maintenance data required for the XPT system. It also provides uplink for transfer of critical stored data in the event of an incident. Note that standard 1 CIF frame size is recommended at this time as cost per byte via the satellite system is significant. Finally the satellite modem will provide downlink for receipt of programming and control functions.

The control and supervisory module (8) provides for the control and management of the XPT system which also allows the system to operate under low visibility conditions such as fog, sleet, snow, heavy rain and mist. The module includes a light intensity monitor (9) for determining when to power up the IR light source. The control and supervisory module also allows for fail safe management and control of the XPT system.

As the XPT system may be powered by solar power (10) or any other power source, the control and supervisory module also includes a power regulator or in the case of solar power a solar system regulator and battery monitoring and management control equipment (11).

The control and supervisory module also provides for the alarm generation and management, sleep mode management and the ability to manage more than one train at any given time Also the control and supervisory module also includes a data base of all active train fitted data radio address codes.

The control and supervisory module also provides for the routing of data from the data radio, satellite modem and the video module. Further, the control and supervisory module may be configured to manage all software upgrades remotely without data corruption should the download be interrupted and allows for the conversion of serial data from the ZVAN data radio system into velocity readings to allow the XPT system to detect approaching vehicles and calculate their velocity for zero visibility conditions in which infrared systems are blind.

In a further arrangement if a particular railroad crossing has power consumption restraints which may preclude the use of an industrial PC, it may be necessary to design a separate module to perform the CPU functions.

The wireless system includes a data radio modem with ethernet connectivity and repeaters to connect multiple ethernet segments, listening to each segment and repeating the signal heard on one segment onto every other segment connected to the repeater to significantly increase the network diameter. The wireless system further may include a low power modem to handle special conditions such as low to zero visibility.

The data radio modem may include a VHF 5 watt data radio modem of 19.2 KB/s capacity with ethernet connectivity. This data radio modem may be used to connect to locomotives in nearby areas. It will be understood that the repeater design is dependent upon the type of terrain and the varying terrain conditions between the train and the railroad crossing. The low power modem to handle special conditions of low to zero visibility for example when the IR camera is blind, operates by polling the system and controlling the ZVAN system (which will be described further below) to switch it on and then receive data regarding motor vehicle speed plus alarm functions.

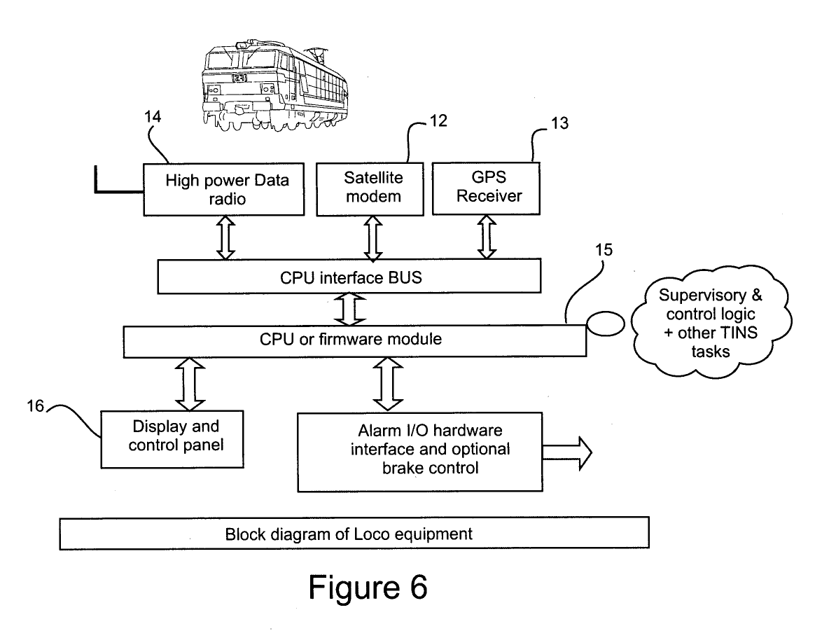

FIG. 6 shows a block diagram of the apparatus located on board a train in accordance with an embodiment of the present invention. The train equipment includes a satellite data modem (12), a GPS receiver (13), data radio (14), a control and supervisory system (15) and a display system (16) for the locomotive engineer. The satellite data modem (12) is used to provide communications with a central server for back up communications for the XPT system should the primary communications fail. The data radio (14) is primarily used for communication with crossing equipment.

The control and supervisory system (15) is used to calculate train velocity and the trains position relative to the nearest crossing. A suitable display includes a system which includes graded alarms and ability to display video frames. The display system may further incorporate touch controls.

In a further arrangement the XPT system may include an in-vehicle transponder installed in motor vehicles to provide in-cabin alerts. This warns the driver by a visual and audible means that they are approaching a railway crossing with an approaching train. This is of particular value to high-risk vehicles such as heavy-haul trucks, school buses and farm vehicles which warns following vehicles of the proximity of the train.

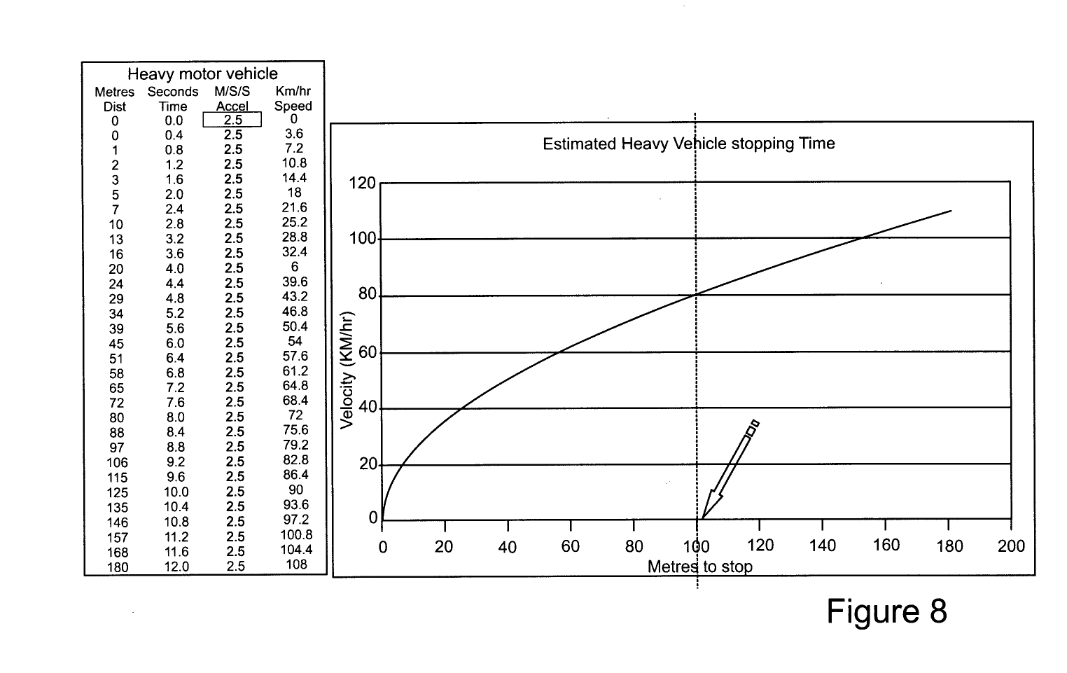

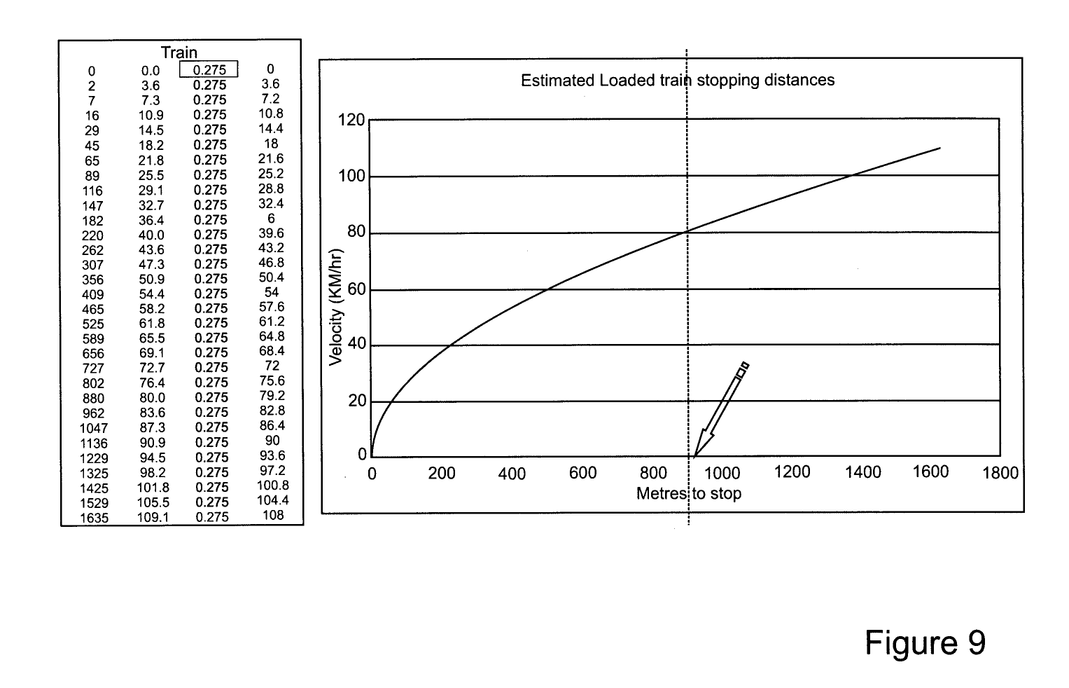

It is also possible to further include into the XPT system a system to predict likely collisions/incidents based upon braking profiles of rolling stock and heavy motor vehicles. The results of the predictions can be used to implement emergency braking protocols in locomotives if desired. FIGS. 8 and 9 show a sample calculation of the estimated stopping times for both trains and motor vehicles.

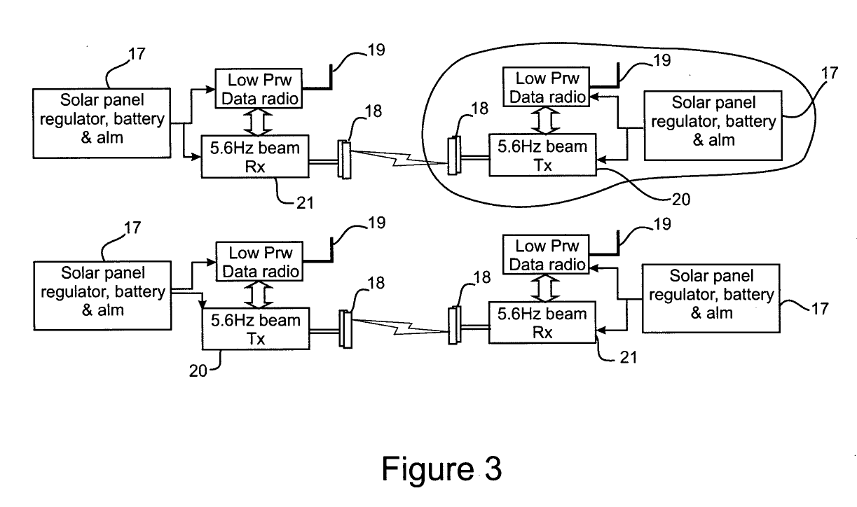

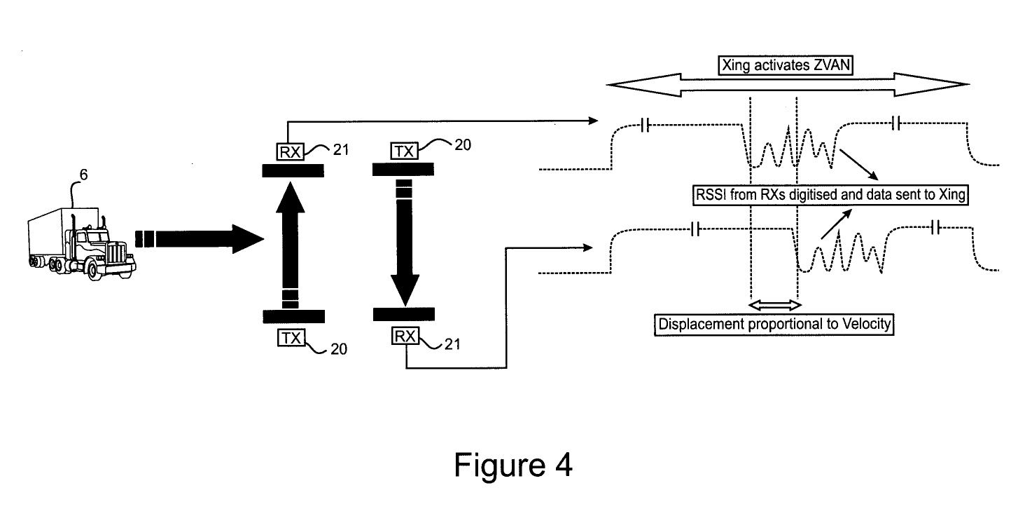

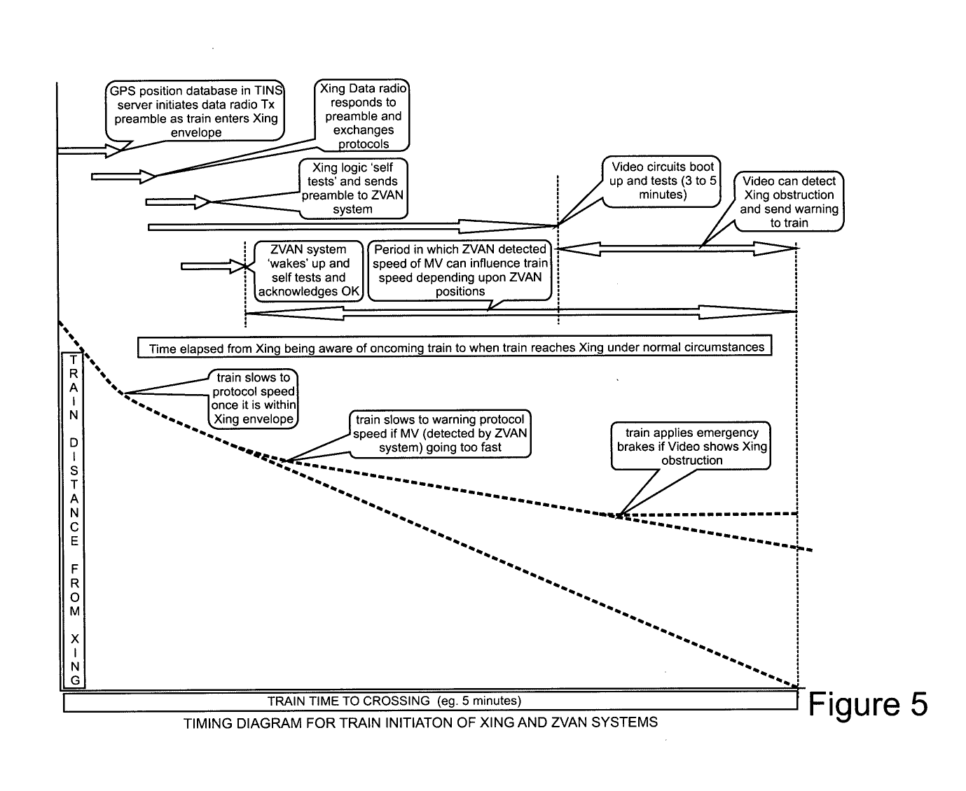

The XPT system may also include a system to detect approaching vehicles and calculate their velocity for zero visibility conditions in which infrared systems are blind. FIGS. 3, 4 and 5 show drawings and waveform for the zero visibility system. The approach obviates the necessity to install buried road sensors and does not require hard wiring to the crossing equipment from the sensors.

Fail safe operation is also considered a design prerequisite as is vandal protection and mean time between failure considerations. Attention is drawn to the differing climate conditions which may exist as the systems are roiled out, hence the need for design considerations of temperature ratings. Self testing protocols are initiated and reported upon system activation, remotely or at periodic intervals of no traffic conditions.

For international and local operation of the system it also envisaged that there will be a requirement to obtain site approvals, licensing of equipment or regulatory and statuary requirements which may exist in certain countries. Similarly it is also possible to include remote server software necessary for billing and administrative information.

The XPT system may be installed into train and railroad crossings in a number of different configurations as follows:

i) A Basic XPT system;

ii) Enhanced function system 1;

iii) Enhanced function system 2; and

iv) Enhanced function system 3;

Each configuration will now be described in more detail.

### A Basic XPT System

The simplest system requires that an approaching train activates the crossing lights (and operate boom gates if required). Even this system requires a backup data path to ensure that the crossing gets the signal that a train is approaching.

In the preferred arrangement once a crossing receives a signal from a train, the crossing then activates any installed safety features. These could include flashing lights, audible alarms and/or boom gates. For systems that have downroad lights or other alert systems then these can also be activated at the same time so as to provide advice to oncoming traffic of a locomotive approaching the crossing ahead. As a further alternative the system may first switch on the downroad lights depending on the distance of the locomotive from the crossing and the speed of the locomotive, then the safety features at the actual crossing may be activated as the locomotive approaches closer to the crossing. Ideally both the crossing safety features and also the downroad safety features would be controlled and activated wirelessly which has the added advantage of limiting the installation time and cost.

The locomotive includes an additional hardware module in the data radio which provides connectivity between the satellite data modem, the radio data modem, GPS receiver and the display panel. Firmware resides on the module which recognises the location of the train with respect to a crossing position loaded data, thus when the train reaches a particular position at the approach to a crossing, it signals the radio modem to wake up the crossing radio modem and switch on the lights etc. If a response is not received by the train in a predetermined time, it attempts to connect to the crossing via the satellite modem system. Once again a response is expected and if it is not received the train reverts to a predetermined slow down protocol. The function of the additional module is carried out more flexibly by a TINS server if fitted.

Communication with the crossings can be based on the train knowing where it is due to the on-board database and GPS. When the train knows it is in proximity of a crossing it is able to poll the crossing or in certain instances of heavy traffic density, the crossing may be configured to regularly poll for trains. Preferably it will be the first situation that is the train polling the crossing. In a default scenario where the train knows there should be crossing responding to its polling or vice versa and it doesn't, if the crossing is fitted with a GPS communications link the train could poll the crossing through this means. This is the crossing default scenario and can confirm if the crossing is active or out of service.

The crossing system is initialised by the data radio (which switches on its receiver for short intervals) sensing a preamble from an approaching train. Should the train radio address be one of those stored in memory, the crossing system initialises completely and responds to the train data radio. Once communications have been established the crossing system activates the lights. A fail safe mechanism activates if communications fail after the initial establishment of communications. If reestablishment cannot occur, the train equipment informs the driver that there is no communications with the crossing and an appropriate protocol is established.

If the data radio system cannot establish communications at all, the satellite modem is activated and it then performs a default communications function as to the train locomotive and/or central control. An alarm is also transmitted to a central server so that equipment may be examined and repairs undertaken.

The basic XPT system described above can replace the standard level crossing detector systems which rely on the train wheels to activate the crossing lights. The wireless system has the advantage however of also warning the locomotive driver that the lights may not necessarily be activated if they are damaged by vandals, equipment failures or accidental damage etc. This warning can trigger a caution protocol for the train driver to follow. Even providing the locomotive driver advice that the system could not communicate provides valuable information that is not presently available.

### Enhanced Function System 1 (EFS1)

This enhancement adds a video recording system at the crossing and transmits the image to the train, stores vital images and uploads these images to a central server.

As with existing level crossing systems and the basic version of XPT system described above, no recording of incidents occur. The enhanced version provides the features that circumstances leading up to an incident are recorded and available for police and insurance company analysis. The enhanced version carries out this function by having the crossing equipment determine if unsafe conditions occur which may or may not lead to an incident; if they do, a recording of video data is made and available for uplift, but if the incident does not eventuate, the data is erased.

Determining that an incident might occur is implemented by the crossing equipment. The crossing system is aware that a train is approaching at a certain velocity. If no action is taken by the train driver the train will reach the crossing In time T1. Video camera data determines if the crossing area is clear, by monitoring the immediate crossing area and detecting objects/bodies and vehicles in the immediate vicinity. Obstructions may be detected through the use of image recognition software. There are various packages that are suitable for this application, but the preferred arrangement utilises image recognition software that incorporates pixel counting technology and is able to “learn” what is normal and then look for abnormalities. In this arrangement an alarm is created if an abnormality is found. Assuming that the images indicate no obstructions are detected at the crossing area and its immediate surrounds, the train driver takes no action other than to obey the protocols for level crossing approaches.

If, during the period when the lights are activated (train approaching) a transgression is detected by the video system, the image is stored for uplift to a remote server. It is desirable to photograph a number plate of the transgressor, subject to visibility in the IR and daylight visible spectrum, however the cost will rise in uplifting the data to a remote server. Number plate recognition requires approximately sixteen times the data amount per frame. If the transgression persists during the time that the train is approaching, and the train is inside its normal braking distance envelope, a warning is displayed or transmitted to the driver and an image of what is causing the transgression. If the transgression continues to persist and the train is just outside its emergency braking distance envelope, the driver will either apply emergency brakes or they will be applied automatically depending upon the protocols agreed upon for that system. Information about the transgression is passed via the data radio system between the crossing and train assuming that the data radio system has been verified as working correctly by the self test mode on start up. Also video frames which have recorded the transgression are uplifted via the satellite modem to a remote server.

### Enhanced Function System 2 (EFS2)

This enhancement incorporates a zero visibility sensor system that detects approaching vehicles irrespective of the visibility and measures their velocity. The EFS1 enhancement option relies upon the video system to detect transgression which may lead to the creation of an incident. Whilst able to detect obstructions at the crossing, for example a pram, EFS1 is not ideal when:

a) Zero or very poor visibility to IR or visible spectrum exists, such as heavy fog, rain, snow and mist, which may render the crossing video detection system less reliable.

b) The video performance at distances out from the crossing will be a limiting factor in detecting approaching vehicles other than in ideal visual conditions, therefore warnings of potential incidents only come when the transgression has or is about to occur. Addition of video cameras to detect approaching vehicles is not considered feasible due to power consumption issues and the fact that in zero visibility conditions they are of limited assistance. Further the video system is relatively expensive in power budget terms and it is preferable to have only one camera which concentrates on the immediate crossing area.

EFS2 therefore seeks to also implement an advanced warning of approaching motor vehicles irrespective of visibility conditions. The solution should determine velocity of the advancing motor vehicle and since its distance is known at the time of velocity measurement, a more accurate warning profile can be calculated to warn the advancing train of an impending collision. To this end, a zero visibility approach system (ZVAN) has been developed. The ZVAN system is capable of operating in any weather conditions and zero visibility. The following is a description of a ZVAN system.

Unless a crossing system which relies upon remote warning of approaching vehicles can perform in sleet, snow, heavy rain, dense mist or fog, then it is of little value in some locations. The ZVAN system looks to provide a relatively simple system that will not appreciably add to the overall complexity, and hence reduce mean time between failures of the overall system; nor be a high profile target for vandals and would be marksmen, whilst most importantly, providing a reliable solution.

On each road approach preferably two sets of four posts mounted in a bedstead format are required for reasons which will be explained later in this text. Although a single set of four posts could be utilised on each road for a simpler system which may be preferred in some installations, Similarly, the implementation may require less than or more than 4 posts in each set. The key is to ensure point to point radio communication. Each post (18) would ideally be around 3 metres high to assist with point to point radio transmission, and include a small solar panel plus the internally housed following equipment;—

i) Solar panel regulator and battery (17). The battery and regulator should be enclosed inside the post (18) which would be about 10 cm by 20 cm.

ii) 5.6 GHz patch antenna (19) (approx 4 cm by 3 cm) facing to opposing pole on other side of road, ideally integral with the pole and virtually undetectable.

iii) Low power 5.6 Ghz (100 microwatt) transmitter (20) and narrow band receiver (21) on the opposite side post.

iv) Piccolo or similar low power general purpose data transceiver for contact with crossing equipment. Firmware could include a ‘sleep’ mode.

v) Suitable interface logic.

vi) A ‘back’ channel facility will be provided on the ZVAN system to alert the crossing equipment to turn on its flashing lights. This is accomplished by the ZVAN system being aroused from sleep mode by periodic monitoring of receiver signal strength indicator (RSSI) data from the beam system. The ZVAN system then sends a preamble to the crossing low power data transceiver which alerts it to switch on the lights and wake up the video system (optional because if no train is in the vicinity there is little point in activating the systems and the penalty comes in increased batteries and solar array sizes).

vii) An optional vertical column of IR diodes facing the crossing to be used as a calibration/test beacon for the video circuits. The IR emitters will be designed to oscillate on and off sequentially in such a way as to show as a descending/ascending/descending etc light source in the IR spectrum. This moving light source can be turned on for short periods on a start up and programmed test/calibration routine to test the cameras and determine visibility. This feature will not be required if the crossing camera cannot see the ZVAN posts.

viii) Optional flashing strobes on a second ZVAN system (if installed) to provide a pre-warning to the motor vehicle that a crossing is busy.

The following description of the ZVAN system assumes that a train is detected within the approach window of the crossing and the ZVAN system has been activated to standby mode.

Each ZVAN preferably includes four posts equipped as described above. To be certain of detecting and measuring the velocity of approaching motor vehicles it would be advantageous to have two sets of ZVANs on both approaches to the crossing remembering that one ZVAN set has 4 posts. It is expected that the cost of each ZVAN set will be significantly lower than the cost of excavations for cables and sensors and connection back to the crossing equipment. The following description assumes two sets of ZVANs. The distance apart of the ZVANs (if two sets are installed) will be determined by road geography and probable stopping distances of heavy vehicles.

Consider the first pair of posts of the remotest ZVAN, which can be set well apart and clear of the immediate road verge. When activated (powered up) as they would be, upon the receipt of information by the crossing that a train is approaching, the 5.6 GHz narrow beam very low power system activates and the two posts establish a radio path in one direction. Similarly the other two posts mounted further towards the track establish a radio path in the other direction. The distance between each set of post pairs will be set to circumvent the possibility that a vehicle may stop between the two post pairs of a ZVAN installation and create logical conditions which may cause confusion.

At the cost of increasing battery and solar panel capacity, it might be considered an enhancement to provide flashing strobes on the first pair of posts of the second ZVAN system which activate when a train is approaching the crossing, thus providing a pre warning that a crossing is just ahead and the motor vehicle must stop.

As a motor vehicle moves through the first set of posts the narrow 5.6 GHz beam is momentarily interrupted, this being detected by the 5.6 GHz receiver contained within the post. Similarly a short time later the second set of posts experience the beam cut off as the motor vehicle passes through. If the RSSI curves of the first pair of receivers are compared and averaged there will be a median time when the signal is least (RSSI will fall from median level to below mute as the motor vehicle passes through and the beam is of the correct height from the ground) and this time is stored and compared to the same information from the second set of posts. To increase security it may be useful to modulate the beams with unique codes.

Consider 5.6 GHz as the frequency of operation and assume the lateral distance between the posts is 30 metres. Further, assume each patch antenna has a gain of 10 dBi. Then the expected signal received is approximately −75 dBm if radiated power is +0 dBm and transmitter power is −10 dBm (100 microwatts/50 ohms). It is likely that typical receiver sensitivity will be −100 dBm (narrow band design) therefore a passing motor vehicle is most likely to cause total fading or if not total, deep reductions in RSSI which will be usable as a trigger signal. Some motor vehicles may be equipped with WLAN 5.6 GHz equipment however the narrow bandwidth receivers are riot susceptible to DSSS low power WLAN systems enough to compromise performance, particularly as DSSS transmission sources are ‘seen’ as low power noise by narrow band receivers and are unlikely to adversely affect RSSI.

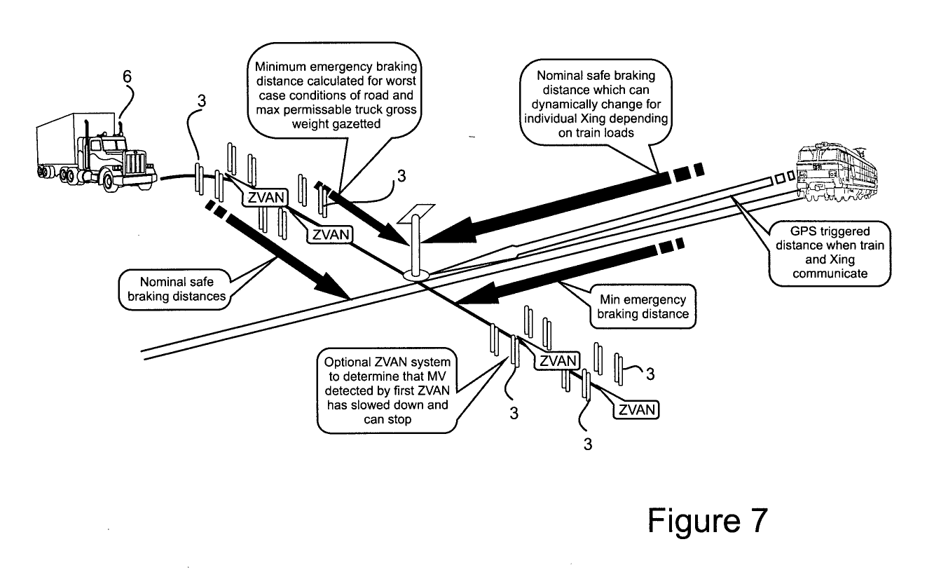

The digitised RSSI readings are then transmitted back to the crossing via the low power data radio network which should not be confused with the main data radio network (train to crossing). For example, while the train crossing transmissions may utilise a 5 watt VHF data link at 19.2 Kb/s, the ZVAN may utilise a 100 milliwatt UHF data link at 38.4 Kb/s. Crossing software converts the data streams into a velocity. The crossing now knows that an approaching motor vehicle has crossed the first zone and it also knows its speed (train approaching and now the flashing lights at the crossing are activated). The second 4 post ZVAN is placed further towards the crossing point to provide a warning of when the second zone is entered, and, like the first ZVAN, transmits the motor vehicle velocity to the crossing. If the second velocity is above a certain threshold, then emergency braking for the train is called for as IC (impending collision) status applies. FIGS. 7, 8 and 9 show typical motor vehicle and train stopping times. This can be inferred because of the distance and velocity of the motor vehicle from the line and the fact that a train is fast approaching. It may be good policy to include a bright strobe light at the crossing so that if IC status is reached, a bright strobe aimed along the road rather than conventional flashing lights, may alert a sleepy or drugged driver to an impending collision.

No system is foolproof and the proposed ZVAN or any vehicle detection system has issues to take into account namely:

a) A determined driver of a motor vehicle could fool the system by slowing down through the first ZVAN (thus not raising the warning status as the system has calculated that the motor vehicle will have well and truly stopped by the time the train has reached the crossing) and mightily accelerating after travelling through the second ZVAN set thereby not leaving enough time for the train to stop. This situation could occur as a driver suddenly decides he/she can beat the train. It should be remembered that no system short of a rapid deployment steel crash barrier can guarantee prevention of a collision with a train at all times under all circumstances.

b) The RSSI pattern generated by moving objects of different shapes and sizes is difficult to analyse for precise velocity measurement trigger points. The simplest solution is to mount the patch antennas at wheel centre height which is relatively constant (in beam size terms) for all motor vehicles. In the case of a multi wheeled heavy vehicle where there will be a number of interruptions to the signals, the logic will choose the first clean negative envelope of RSSI where signal drops a predetermined amount The RSSI readings are converted to a digital sample and hold system for analysis.

c) Small unobtrusive posts even when well set back from the road verge on country roads encourages the occasional rifle shooter to use them for target practice. Proper functioning of the ‘4 poster’ can be tested each time the system is activated (when a train approaches a crossing and at regular intervals or by manual interrogation from the central server when no trains activate the system). If the posts are made from steel, then only the very small fibreglass windows for the beam radios, and the solar panel, are vulnerable to bullets. The fibre glass window will be approximately 50 mm by 40 mm overall size.

d) Whilst the ZVAN post electronics are small and very low power, there is some complexity because comparisons are needed to determine the correct trigger point for RSSI between two posts. All data radios need to be polled by the crossing system. To a small extent the communications protocols for two ZVANs on each road approach resemble an 8 wheel TINS system (like 2 freight cars of 4 wheels each). Each post will have firmware to manage the full functionality of the internal electronics. The crossing system will poll the ZVAN data radios to determine information about test results, status, and motor vehicle velocity.

e) If only one set of ZVAN is used for each road approach, then the warning of approaching motor vehicles and their velocity is still valid but it has to be assumed that the velocity of the approaching motor vehicle will decrease after it has passed through the ZVAN (motor vehicle sees flashing lights and brakes to a halt). This assumption of course is only made if the time taken for the motor vehicle to stop is within the acceptable time window calculated from train velocity and motor vehicle velocity.

### Enhanced Function System 3 (EFS3)

Enhanced function system 3 adds a in-vehicle module to the previous enhancement thus aiding the decision process at the crossing.

This system involves approaching vehicles in the process of determining probable collisions by including an in-vehicle module in the motor vehicles. In an ideal scenario this method is the best, however the practical problem of acceptance of another module by drivers comes down to cost and so called Big brother intrusion. It is impossible to guarantee every vehicle that may cross the railway line has the necessary electronics; thus the methodology may be limited as decisions based upon receipt of in-vehicle module data have to be bypassed in the majority of cases as most vehicles will not be fitted with in-vehicle modules.

An exception to this may be company owned vehicles and in particular vehicles operating on mine sites or other heavy industry sites. For example management of a mine site may prefer their vehicles be fitted with an in-vehicle module so as to further improve safety at the site. Reduced accidents would also decrease operational downtime particularly if truck and rail collisions can be avoided.

The in-vehicle module may also be adapted to provide warnings and alerts to the driver of the vehicle. For example as the vehicle approaches a crossing the driver may be provided with an alert or warning that a railway crossing is ahead. In an alternative the in-vehicle system may be configured to provide an alert if a train is approaching the same crossing that the vehicle is approaching. In this way the driver will be provided with prior warning before reaching the crossing even if the crossing safety features are not operational or visible.

### System Testing And Calibration

Testing and calibration of the system will now briefly be discussed in order to provide a complete picture of the XPT system.

The XPT system is complex, plus it could be subject to damage due to vandalism and other causes. Because the system is intended to avoid collisions, or at the very least, provide evidence of culpability; considerable care should be exercised in design to maximise the self test/health check capability and report status of the system at regular intervals.

### Test And Calibration On Start Up

After a train approaches the crossing, and the crossing system wakes up as result of the long preamble from the locomotive data radio interrupting its sleep mode, a complete suite of tests is initiated.

1. Loco-crossing data path is verified.

2. Crossing activates the ZVAN posts (switch on is the same principle as used to wake up the Xing by the approaching train).

3. Camera facing down detects ground marker and verifies correct operation.

4. ZVAN system tests both way beams and reports status to crossing. ZVAN also sends an artificial set of RSSI codes which would represent a known velocity so that the crossing records a calibrated velocity. These codes would be generated by 5.6 GHz receivers which introduce a switchable attenuator into their circuits to simulate a temporary fade.

5. Crossing satellite modem sends off ALL OK signal to central server.

6. Server sends confirmation signal to Loco Satellite modem (System OK on display unit).

### Automatic Test Initiation When Lone Periods of No Train Traffic Occurs

It may be that several days pass before a train approaches a crossing and in that time malfunctions or vandalism may have caused all or part of the ground based systems (Crossing and ZVAN systems) to fail in their primary task. Sequences are as follows:

1. Crossing system timer determines that no activity has occurred (no data received from data radio or Satellite modem.

2. Crossing switches on ZVAN posts including IR moving markers, if fitted. Switch on is same principle as crossing wake up.

3. Camera facing down detects ground marker and verifies correct operation.

4. ZVAN system tests both way beams and reports status to crossing.

5. Crossing satellite modem sends off ALL OK signal to central server.

6. Crossing receives acknowledgement that server has received status OK and shuts down the site to wait for next ‘wake up’.

### Manual Initiation of Test Sequences From Server

There may be times when a customer or service manager may wish to carry out routine testing of all sites. This is done from a remote server by selecting the crossing address and initiating a sequence of tests as follows;—

1. Crossing switches on ZVAN posts including IR moving markers. Switch on is same principle as crossing wake up.

2. Camera facing down detects ground marker and verifies correct operation.

3. ZVAN system tests both way beams and reports status to crossing.

4. Crossing satellite modem sends off ALL OK signal to central server.

5. Server records successful test date and time plus major parameters such as battery status.

The present invention therefore provides a number of advantages over conventional systems. These advantages include that the present invention provides a unique stand-alone, light weight and relatively low cost system that can be installed at current unprotected crossings or can be deployed at conventionally protected crossings to add functionality to the existing crossings, for example the in-cabin alert feature, which is able to alert a locomotive driver of a motor vehicle approaching either a protected or unprotected crossing. In this regard the ability to warn a locomotive driver whether a protected crossing system is working and online is a significant improvement alone over existing systems. The present invention also does not require any engineering or construction interference with the track, where as conventional systems require track circuits to be triggered by the train as they pass over them to set the crossing system working. As an added feature the present invention can also integrate road user crossing violator recording systems that could then be matched with police records to issue infringements.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

1. A method of operating a railway crossing including the steps of:
receiving a signal from a locomotive;
determining whether said crossing is obstructed; and
communicating whether said crossing is obstructed to said locomotive.

2. A method as claimed in claim 1 further including activating crossing warning devices.

3. A method as claimed in claim 2 wherein said warning devices are activated when said polling signal is received.

4. A method as claimed in claim 2 wherein said warning devices include lights, audible sounds and/or barriers.

5. A method as claimed in claim 1 further including capturing a video image of said crossing and transmitting said video image to said locomotive.

6. A method as claimed in claim 1 further including analysing oncoming vehicle traffic to determine whether a collision between said locomotive and said vehicle is probable and communicating said analysis to said locomotive.

7. A method of managing the approach of a locomotive to a crossing including the steps of:
sending a signal from said locomotive to said crossing; and
if unable to initiate communications between said locomotive and said crossing taking predetermined steps to control the approach of said locomotive to said crossing.

8. A method as claimed in claim 7 wherein said locomotive sends said signal when a GPS system on said locomotive indicates that said train is a predetermined distance from said crossing.

9. A rail crossing safety system including
a communications means adapted to send and receive signals to a locomotive;
a video capture means to capture images of said crossing; and
a processor to determine if said crossing is obstructed;
and wherein said system communicates to said locomotive whether said crossing is obstructed.

10. A system as claimed in claim 9 wherein said communications means is wireless, satellite or a GPS link.

11. A system as claimed in claim 9 further including warning devices adapted to be activated when signals are received from said locomotive.

12. A system as claimed in claim 11 wherein said warning devices include lights, audible sounds or barriers.

13. A system as claimed in claim 9 further including an oncoming vehicle analysis means to determine if approaching vehicles are likely to collide with said locomotive and communicating findings to said locomotive.

14. A system as claimed in claim 9 further including an infrared light source which is activated when a light sensor detects low light.

15. A system for detecting the approach of vehicles on a road including:
a first pair of posts located on opposite sides of said road; and a second pair of posts located on opposite sides of said road; said first pair of posts and said second pair of posts forming the corners of a quadrilateral; wherein a first beam is transmitted between said first pair of posts, and a second beam is transmitted between said second pair of posts; and
a processor for detecting if said first beam is broken, and whether said second beam is broken indicating the passing of a vehicle between said first and second pair of posts.

16. A system as claimed in claim 15 wherein said first beam and said second beam travel in opposite directions.

17. A system as claimed in claim 15 wherein said processor further measures the time differential between said first beam being broken and said second beam being broken to thereby calculate the velocity of said vehicle.

18. A method for detecting the approach of vehicles on a road including the steps of:
transmitting a first beam between a first pair of posts located on opposite sides of a road, and transmitting a second beam between a second pair of posts located on opposite sides of a road, wherein said first pair of posts and said second pair of posts form the corners of a quadrilateral; and
detecting if said first beam is broken, and whether said second beam is broken thereby indicating the passing of a vehicle between said first and second pair of posts.

19. A method as claimed in claim 18 wherein said first beam and said second beam travel in opposite directions.

20. A method as claimed in claim 18 further including the step of measuring the time differential between said first beam being broken and said second beam being broken to thereby calculate the velocity of said vehicle.

21. A rail crossing safety system including
a first module located on a locomotive, said first module including
a first communication means; and
a second module located at a crossing, said second module including
a second communications means adapted to send and receive signals from said first communication means;
a video capture means to capture images of said crossing; and
a processor to determine if said crossing is obstructed;
and wherein said second module communicates to said first module whether said crossing is obstructed.

22. A method of operating a railway crossing including the steps of:
receiving a signal from a locomotive; and
activating crossing warning devices and/or downroad warning devices.

23. A method as claimed in claim 22 wherein said warning devices include lights, audible sounds and/or barriers;

24. A method as claimed in claim 22 further including sending a signal to the locomotive to indicate the crossing is operational.

25. A method as claimed in claim 22 wherein said warning devices are activated via a wireless communication means.

26. A method of managing the approach of a locomotive to a crossing including the steps of:
sending a signal from said locomotive to said crossing; and
if unable to initiate communications between said locomotive and said crossing alerting a driver of said locomotive.

27. A rail crossing safety system including
a communications means adapted to send and receive signals to a locomotive; and
at least one safety device;
wherein said system activates said at least one safety device following receipt of a signal from said locomotive.

28. A system as claimed in claim 27 wherein said at least one safety device includes lights, audible sounds and/or barriers.

29. A system as claimed in claim 27 wherein said at least one safety device includes a first set of devices located at said crossing and a second set of devices located downroad.

30. A system as claimed in claim 29 wherein said second set of devices are activated prior to said first set of devices.

31. A rail crossing protection system and method for a railroad crossing, said rail crossing protection system and method including:
at least one train on at least one train line, wherein said at least one train approaching a railroad crossing activates said rail crossing protection system;
said at least one train including:
i) a data server for storing train information and generating periodic messages;
ii) a communication means for transmitting said train information and periodic messages to said rail crossing protection system;
iii) a receiving means for receiving railroad crossing information from said rail crossing protection system; and
iv) a location determining means which recognises the location of the train with respect to a railroad crossing;
said rail crossing protection system including:
i) a power source;
ii) a controller for receiving said periodic messages from said train to activate said rail crossing protection system; and
a means for providing an indication of crossing condition to said train approaching the railroad crossing.
